(19) United States
(12) Patent Application Publication
(10) Pub. No.: US 2013/0164617 A1
(43) Pub. Date: Jun. 27, 2013

(54) ANODE MATERIAL, LITHIUM SECONDARY BATTERY, AND METHOD FOR PRODUCING ANODE MATERIAL

(71) Applicant: Hiroyuki Yamaguchi, Susono-shi (JP)

(72) Inventor: Hiroyuki Yamaguchi, Susono-shi (JP)

(73) Assignee: TOYOTA JIDOSHA KABUSHIKI KAISHA, Toyota-shi, Aichi (JP)

(21) Appl. No.: 13/704,497

(22) PCT Filed: Jun. 16, 2011
(86) PCT No.: PCT/JP2011/063821

§ 371 Date: Dec. 14, 2012

(30) Foreign Application Priority Data
Aug. 31, 2010 (JP) 2010-194781

(51) Int. Cl. H01M 4/131

(52) U.S. Cl. CPC H01M 4/131
USPC 429/213; 252/182.1

(57) ABSTRACT

The main object of the present invention is to provide an anode material capable of improving cycling characteristics of a lithium secondary battery. The present invention solves the problem by providing an anode material comprising a reactant between: a metal oxide represented by a general formula of MₓO_{y} (M is a metal) or a metal represented by a general formula of M, which causes an alloying reaction or a conversion reaction with Li, and a polymer compound having an acid group in a side chain.

### TECHNICAL FIELD

The present invention relates to an anode material capable of improving cycling characteristics of a lithium secondary battery.

### BACKGROUND ART

In accordance with a rapid spread of information relevant apparatuses, communication apparatuses and the like such as a personal computer, a video camera and a portable telephone in recent years, the development of a battery to be utilized as a power source thereof has been emphasized. The development of a high-output and high-capacity battery for an electric automobile or a hybrid automobile has been advanced also in the automobile industry and the like. A lithium secondary battery has been presently noticed from the viewpoint of a high energy density among various kinds of batteries.

A material containing Si or Sn higher in theoretical capacity than carbon has been researched as an anode active material used for a lithium secondary battery. In the case of using an active material containing Si or Sn for an anode, volume change due to expansion and contraction of the active material caused during an insertion elimination reaction of lithium is so large that the collapse of the anode in accordance with the repetition of charge and discharge is great, and there is a problem that the decrease of electrical contact between the anode and a current collector and the increase of internal resistance due to the disconnection of a conductive path in the anode are caused easily.

On the contrary, a lithium secondary battery comprising an anode containing an anode active material containing Si or Sn and a polyacrylic acid is disclosed in each of Patent Literatures 1 to 3. The use of a polyacrylic acid with high strength as a binder of the anode allows the anode to be restrained from collapsing due to expansion and contraction of the anode active material.

### CITATION LIST

### Patent Literature

Patent Literature 1: Japanese Patent Application Publication Laid-Open (JP-A) No. 2000-348730
Patent Literature 2: JP-A No. 2005-197258
Patent Literature 3: JP-A No. 2009-252348

### SUMMARY OF INVENTION

### Technical Problem

However, an anode material containing Si or Sn described in each of Patent Literatures 1 to 3 is micronized for the reason that shape change due to the insertion elimination of lithium is large, and consequently offers no electron conduction and may not be involved in a charge and discharge reaction to bring a problem that cycling characteristics of a lithium secondary battery are decreased.

The present invention has been made in view of the problem, and a main object thereof is to provide an anode material capable of improving cycling characteristics of a lithium secondary battery.

### Solution to Problem

To solve the problem, the present invention provides an anode material comprising a reactant between: a metal oxide represented by a general formula of MₓO_{y} (M is a metal) or a metal represented by a general formula of M, which causes an alloying reaction or a conversion reaction with Li; and a polymer compound having an acid group in a side chain.

According to the present invention, a metal atom of the metal oxide or the metal, which interacts with the acid group of the polymer compound, is previously dispersed so highly into the anode material by bonding in an atomic level that electrical conductivity may be maintained even though the shape change of the anode material in accordance with the insertion elimination of lithium is caused, and cycling characteristics of a lithium secondary battery may be improved.

In the invention, M is preferably Bi, Sb, Sn, Si, Al, Pb, In, Mg, Ti, Zr, V, Fe, Cr, Cu, Co, Mn, Ni, Zn, Nb, Ru, Mo, Sr, Y, Ta, W, or Ag in the general formula.

In the invention, the metal oxide or the metal are preferably bismuth oxide (Bi₂O₃), tin oxide (SnO), or tin (Sn).

In the invention, the acid group is preferably a carboxylic acid group or a sulfonic acid group.

Further, the present invention provides a lithium secondary battery comprising a cathode active material layer, an anode active material layer, and an electrolyte layer formed between the cathode active material layer and the anode active material layer, characterized in that the anode active material layer is formed by using the anode material.

According to the present invention, the use of the above-mentioned anode material allows a lithium secondary battery excellent in cycling characteristics.

Further, the present invention provides a method for producing an anode material comprising steps of: a preparation step of preparing a reaction liquid containing: a metal oxide represented by a general formula of MₓO_{y} (M is a metal) or a metal represented by a general formula of M, which causes an alloying reaction or a conversion reaction with Li; a polymer compound having an acid group in a side chain; and a polar solvent; and a reaction step of reacting the metal oxide or the metal with the polymer compound by stirring the reaction liquid while heating.

According to the present invention, the metal oxide or the metal is reacted with the polymer compound, so that a metal atom of the metal oxide or the metal, which interacts with the acid group of the polymer compound, may be previously dispersed highly into the anode material by bonding in an atomic level. Thus, electrical conductivity may be maintained even though the shape change of the anode material in accordance with the insertion elimination of lithium is caused, and the anode material capable of improving cycling characteristics of a lithium secondary battery may be obtained.

### Advantageous Effects of Invention

The present invention produces the effect such as to allow cycling characteristics of a lithium secondary battery to be improved.

### BRIEF DESCRIPTION OF DRAWINGS

FIG. 1 is a schematic cross-sectional view showing an example of a lithium secondary battery of the present invention.

FIG. 2 is a flow chart showing an example of a method for producing an anode material of the present invention.

FIG. 3 is a graph showing a result of XRD measurement of a reactant obtained in Synthesis Example 1.

FIG. 4 is a graph showing a result of XRD measurement of a reactant obtained in Synthesis Example 2.

FIG. 5 is a graph showing a result of XRD measurement of bismuth oxide (Bi₂O₃).

FIG. 6 is a graph showing a result of XRD measurement of tin oxide (SnO).

FIG. 7 is a graph showing a result of evaluating cycling characteristics of an evaluation battery obtained in Example 1 and Comparative Example 1.

FIG. 8 is a graph showing a result of evaluating cycling characteristics of an evaluation battery obtained in Example 2 and Comparative Example 2.

FIG. 9 is a graph showing a result of XRD measurement of a working electrode (a test electrode) after 60-cycle charge and discharge of an evaluation battery obtained in Example 2 and Comparative Example 2.

### DESCRIPTION OF EMBODIMENTS

An anode material, a lithium secondary battery, and a method for producing an anode material of the present invention are hereinafter described in detail.

A. Anode Material

First, an anode material in the present invention is described. The anode material in the present invention comprises a reactant between: a metal oxide represented by a general formula of MₓO_{y} (M is a metal) or a metal represented by a general formula of M, which causes an alloying reaction or a conversion reaction with Li; and a polymer compound having an acid group in a side chain.

According to the present invention, in a reactant between the metal oxide or the metal, and the polymer compound, it is conceived that a metal atom of the metal oxide or the metal bonds to the polymer compound by interacting with an acid group in a side chain of the polymer compound, and consequently that the metal atom is dispersed highly. As described above, an anode material containing Si or Sn described in each of Patent Literatures 1 to 3 is micronized in accordance with charge and discharge for the reason that shape change of the anode material due to the insertion elimination of lithium is large, and an electron conductive path is cut.

On the contrary, in the present invention, the use of the reactant for an anode material allows the anode material not to be micronized even though the shape change of the anode material in accordance with the insertion elimination of lithium is caused, and the metal atom is previously dispersed so highly into the anode material that an electron conductive path is not cut easily and favorable electrical conductivity may be maintained with time. Accordingly, when the anode material of the present invention is used for a lithium secondary battery, cycling characteristics may be improved.

The anode material of the present invention is hereinafter described in each constitution.

1. Reactant

First, a reactant in the present invention is described. The reactant in the present invention is obtained by reacting a metal oxide represented by a general formula of MₓO_{y} (M is a metal) or a metal represented by a general formula of M, which cause an alloying reaction or a conversion reaction with Li, with a polymer compound having an acid group in a side chain, and specifically the reactant is conceived to be such that a metal atom of the metal oxide or the metal bonds to an acid group in aside chain of the polymer compound by interaction.

(1) Metal Oxide or Metal The metal oxide or the metal in the present invention are represented by a general formula of MₓO_{y} (M is a metal) or a general formula of M respectively, which causes an alloying reaction or a conversion reaction with Li. In the present invention, a metal atom of the metal oxide or the metal is conceived to react with an acid group in a side chain of a polymer compound, which will be mentioned later.

The metal oxide or the metal in the present invention causes an alloying reaction or a conversion reaction with Li. Here, the alloying reaction signifies a reaction such that the metal oxide or the metal reacts with a metal ion such as an Li ion to change into an alloy such as an Li alloy, and the conversion reaction signifies a reaction such that the metal oxide reacts with a metal ion such as an Li ion, is reduced, and changes into the metal and a different metal oxide from the original metal oxide, such as an Li oxide. Further, the produced metal occasionally reacts with a metal ion such as a Li ion to change into an alloy such as a Li alloy.

Further, the metal oxide and the metal in the present invention are represented by a general formula of MₓO_{y} (M is a metal) and a general formula of M, respectively. M is preferably Bi, Sb, Sn, Si, Al, Pb, In, Mg, Ti, Zr, V, Fe, Cr, Cu, Co, Mn, Ni, Zn, Nb, Ru, Mo, Sr, Y, Ta, W, or Ag in the general formula. In the present invention, above all, M is preferably a metal which forms an amphoteric oxide. The reason therefor is to react with the acid. Specifically, M is more preferably Bi, Sn and Sb, and far more preferably Bi or Sn. That is to say, the metal oxide or the metal in the present invention are preferably bismuth oxide (Bi₂O₃), tin oxide (SnO), or tin (Sn). The reason therefor is that they easily react with the acid. Incidentally, in the present invention, M may contain two kinds or more of metals. In particular, the metal oxide in the present invention is preferably SnO. The reason therefor is that it is conceived that when a lithium secondary battery using the anode material of the present invention is charged and discharged, two phases of α-Sn and β-Sn are detected as Sn phases in the anode material to improve the discharge capacity maintenance factor of the lithium secondary battery. It is conceived that the reason therefor is that the two metallic phases mutually relieve volume change during the insertion elimination of lithium.

(2) Polymer Compound

A polymer compound in the present invention has an acid group in a side chain. In the present invention, an acid group in a side chain of the polymer compound is conceived to react with a metal atom of the metal oxide or the metal.

The acid group in a side chain of the polymer compound in the present invention is not particularly limited if the acid group may react with a metal atom of the metal oxide or the metal; examples thereof include a carboxylic acid group, a sulfonic acid group and a hydroxyl group. In the present invention, above all, a carboxylic acid group or a sulfonic acid group is preferable. The reason therefor is that reactivity is high.

The polymer compound used for the present invention is not particularly limited if the polymer compound has the above-mentioned acid group in a side chain; examples thereof include polyacrylic acid, polymethacrylic acid, polymaleic acid, polyamic acid and polysulfonic acid. In the present invention, above all, polyacrylic acid is preferable. The reason therefor is that the acid group amount in a side chain is so large as to offer low costs.

The number-average molecular weight of the polymer compound used for the present invention is, for example, preferably within a range of 1000 to 20000000, more preferably within a range of 1500 to 3000000, and far more preferably within a range of 1800 to 3000000. Incidentally, the number-average molecular weight may be measured by a standard polystyrene conversion method using gel permeation chromatography (GPC).

(3) Reactant

A reactant in the present invention is conceived to be such that a metal atom of the metal oxide or the metal bonds to an acid group in a side chain of the polymer compound. It may be confirmed by, for example, infrared spectrometry (IR) measurement that a metal atom of the metal oxide or the metal bonds to an acid group in a side chain of the polymer compound.

Further, it may be confirmed by X-ray diffraction (XRD) measurement that the reactant in the present invention is a reactant between the metal oxide or the metal, and the polymer compound. Specifically, in the case where the reactant and the metal oxide or the metal on the same conditions are measured, a halo pattern appears in XRD measurement result of the reactant, which does not offer any peculiar peaks to the metal oxide or the metal, or offers a peak whose intensity is decreased to 10% or less, preferably 5% or less, in the case where the intensity of the peak in XRD measurement result of the metal oxide or the metal is regarded as 100%, and it may be determined that the reactant is a reactant between the metal oxide or the metal, and the polymer compound.

The reactant in the present invention is ordinarily powdery, and the average particle diameter thereof is, for example, preferably within a range of 0.1 μm to 100 μm, and more preferably within a range of 1 μm to 20 μm.

With regard to the reactant in the present invention, since a metal atom of the metal oxide or the metal, which interacts with the acid group of the polymer compound, is dispersed previously, an electron conductive path is not cut easily even though shape change due to the insertion elimination of lithium is caused, and the use of the reactant for an anode material allows cycling characteristics of a lithium secondary battery to be improved.

2. Anode Material

An anode material of the present invention may be appropriately used for a lithium secondary battery, for example. On that occasion, the anode material may consist of only the reactant, or preferably contains a conductive material further in addition to the reactant. The reason therefor is to allow the anode material with favorable electron conductivity. The conductive material is not particularly limited, but examples thereof include carbon materials such as mesocarbon microbeads (MCMB), acetylene black, Ketjen Black, carbon black, coke, carbon fiber, vapor-grown carbon, and graphite.

The content of the conductive material in the anode material of the present invention is not particularly limited but is, for example, preferably within a range of 1% by weight to 60% by weight, and more preferably within a range of 2% by weight to 40% by weight. The reason therefor is that too small ratio of the conductive material brings a possibility of being incapable of sufficiently improving electron conductivity, while too large ratio of the conductive material brings a possibility of relatively decreasing the ratio of the reactant to increase capacity reduction.

Further, the anode material of the present invention is preferably micronized. The reason therefor is that specific surface area may be increased to improve the utilization efficiency of the anode material. Above all, the anode material of the present invention is preferably micronized by mechanical milling. The reason therefor is that mechanical milling is a method for milling a test sample while applying mechanical energy, in which the anode material may be micronized more remarkably than simple micronization (such as micronization using a mortar) and the conductive material may be dispersed uniformly on the surface of the reactant. Examples of the mechanical milling include ball mill, vibrating mill, turbo mill, mechano-fusion and disk mill, and ball mill is preferable above all.

B. Lithium Secondary Battery

Next, a lithium secondary battery of the present invention is described. The lithium secondary battery of the present invention is a lithium secondary battery comprising a cathode active material layer, an anode active material layer, and an electrolyte layer formed between the cathode active material layer and the anode active material layer, characterized in that the anode active material layer is formed by using the above-mentioned anode material.

According to the present invention, the use of the above-mentioned anode material allows a lithium secondary battery excellent in cycling characteristics.

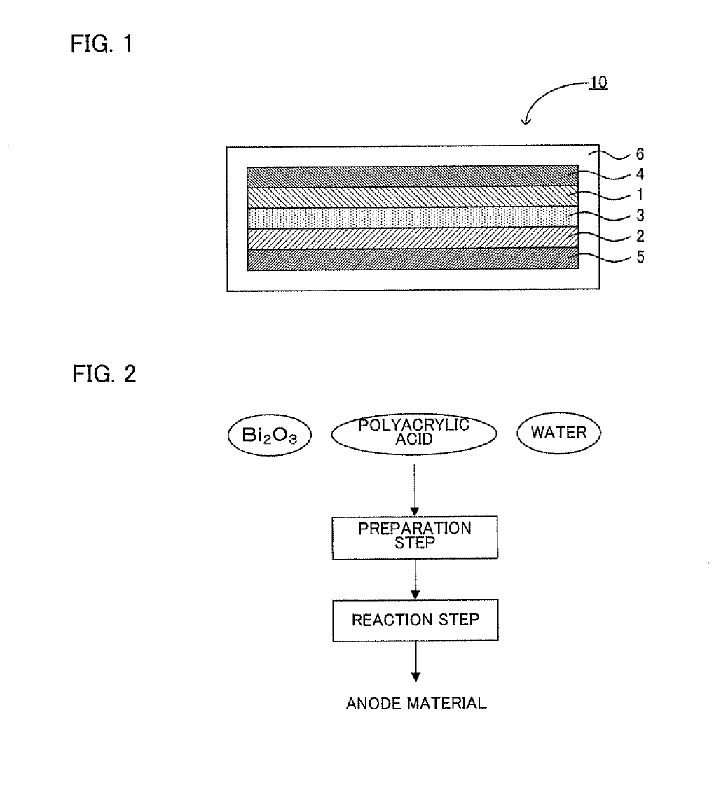

FIG. 1 is a schematic cross-sectional view showing an example of the lithium secondary battery of the present invention. A lithium secondary battery 10 exemplified in FIG. 1 comprises a cathode active material layer 1, an anode active material layer 2, an electrolyte layer 3 formed between the cathode active material layer 1 and the anode active material layer 2, a cathode current collector 4 for collecting currents of the cathode active material layer 1, an anode current collector 5 for collecting currents of the anode active material layer 2, and a battery case 6 for storing these members. The present invention is greatly characterized in that the anode active material layer 2 is formed by using the anode material described in the ‘A. Anode material’. In particular, in the case where a metal oxide in the anode material is tin oxide (SnO), two phases of α-Sn and β-Sn as Sn phases are confirmed in the anode active material layer in the lithium secondary battery after charge and discharge.

The lithium secondary battery of the present invention is hereinafter described in each constitution.

1. Anode Active Material Layer

First, an anode active material layer in the present invention is described. The anode active material layer in the present invention is a layer formed by using at least the above-mentioned anode material, and may contain at least one of a binder and a conductive material as required. The content of the anode material in the anode active material layer is not particularly limited but is, for example, preferably 20% by weight or more, and more preferably within a range of 40% by weight to 80% by weight. Further, examples of the binder include polyimide, polyamideimide and a polyacrylic acid. Further, as described above, the anode material itself occasionally contains the conductive material, and the anode active material layer may further contain the conductive material. The conductive material contained in the anode material and the conductive material added further may be the same material or a different material. Incidentally, specific examples of the conductive material are as described above. The thickness of the anode active material layer is, for example, preferably within a range of 0.1 μm to 1000 μl.

A general method may be used as a method for forming the anode active material layer. For example, the anode active material layer may be formed in such a manner that an anode active material layer forming paste containing the anode material, binder and conductive material is applied and dried on the anode current collector, which will be described later, and thereafter pressed. In the present invention, the anode active material layer after being pressed is preferably burned further under an inert gas atmosphere such as a nitrogen atmosphere. The reason therefor is to allow the anode active material layer more excellent in cycling characteristics. The burning temperature is, for example, preferably within a range of 200° C. to 1000° C., and more preferably within a range of 300° C. to 700° C. Further, the burning time is, for example, preferably within a range of 1 hour to 30 hours, and more preferably within a range of 2 hours to 20 hours.

2. Cathode Active Material Layer

Next, a cathode active material layer in the present invention is described. The cathode active material layer in the present invention is a layer containing at least a cathode active material, and may contain at least one of a conductive material and a binder as required. Examples of the cathode active material include bed type cathode active materials such as LiCoO₂, LiNiO₂, LiCo_{1/3}Ni_{1/3}Mn_{1/3}O₂, LiVO₂ and LiCrO₂, spinel type cathode active materials such as LiMn₂O₄, Li (Ni_{0.25}Mn_{0.75})₂O₄, LiCoMnO₄ and Li₂NiMn₃O₈, and olivine type cathode active materials such as LiCoPO₄, LiMnPO₄ and LiFePO₄. The content of the cathode active material in the cathode active material layer is not particularly limited but is, for example, preferably within a range of 40% by weight to 99% by weight.

The cathode active material layer in the present invention may further contain at least one of a conductive material and a binder. The conductive material and the binder are the same as the contents described in the ‘1. Anode active material layer’; therefore, the description herein is omitted. The thickness of the cathode active material layer is, for example, preferably within a range of 0.1 μm to 1000 μm.

A general method may be used as a method for forming the cathode active material layer. For example, the cathode active material layer may be formed in such a manner that a cathode active material layer forming paste containing the cathode active material, the binder and the conductive material is applied and dried on the cathode current collector, which will be described later, and thereafter pressed.

3. Electrolyte Layer

Next, an electrolyte layer in the present invention is described. The electrolyte layer in the present invention is a layer formed between the cathode active material layer and the anode active material layer. Li ion conduction between a cathode active material and an anode active material is performed through an electrolyte contained in the electrolyte layer. The form of the electrolyte layer is not particularly limited but examples thereof include a liquid electrolyte layer, a gel electrolyte layer and a solid electrolyte layer.

The liquid electrolyte layer is ordinarily a layer obtained by using a nonaqueous liquid electrolyte. The nonaqueous liquid electrolyte ordinarily contains a lithium salt and a nonaqueous solvent. Examples of the lithium salt include inorganic lithium salts such as LiPF₆, LiBF₄, LiClO₄ and LiAsF₆; and organic lithium salts such as LiCF₃SO₃, LiN(CF₃SO₂)₂, LiN(C₂F₅SO₂)₂ and LiC(CF₃SO₂)₃. Examples of the nonaqueous solvent include ethylene carbonate (EC), fluoroethylene carbonate (FEC), difluoroethylene carbonate (DFEC), propylene carbonate (PC), dimethyl carbonate (DMC), diethyl carbonate (DEC), ethyl methyl carbonate (EMC), butylene carbonate (BC), γ-butyrolactone, sulfolane, acetonitrile, 1,2-dimethoxymethane, 1,3-dimethoxypropane, diethyl ether, tetrahydrofuran, 2-methyltetrahydrofuran, and mixtures thereof. The concentration of the lithium salt in the nonaqueous liquid electrolyte is, for example, within a range of 0.5 mol/L to 3 mol/L. Incidentally, in the present invention, a low-volatile liquid such as an ionic liquid may be used as the nonaqueous liquid electrolyte.

The thickness of the electrolyte layer varies greatly with kinds of the electrolyte and constitutions of the battery, and is, for example, preferably within a range of 0.1 μM to 1000 μm, and above all, preferably within a range of 0.1 μm to 300 μm.

4. Other Constitutions

The lithium secondary battery of the present invention may further comprise a cathode current collector for collecting currents of the cathode active material layer and an anode current collector for collecting currents of the anode active material layer. Examples of a material for the cathode current collector include SUS, aluminum, nickel, iron, titanium and carbon, and preferably aluminum above all. On the other hand, examples of a material for the anode current collector include SUS, copper, nickel and carbon, and preferably copper above all. Further, the thickness, shape and the like of the cathode current collector and the anode current collector are preferably selected properly in accordance with factors such as uses of the lithium secondary battery.

The lithium secondary battery of the present invention may comprise a separator between the cathode active material layer and the anode active material layer. The reason therefor is to allow the lithium secondary battery with higher safety. Examples of a material for the separator include porous membranes such as polyethylene, polypropylene, cellulose and polyvinylidene fluoride; and nonwoven fabrics such as resin nonwoven fabric and glass fiber nonwoven fabric. Further, a battery case of a general lithium secondary battery may be used for a battery case used for the present invention. Examples of the battery case include a battery case made of SUS.

5. Lithium Secondary Battery

The lithium secondary battery of the present invention is preferably used as a car-mounted battery, for example. Examples of the shape of the lithium secondary battery of the present invention include a coin shape, a laminate shape, a cylindrical shape and a rectangular shape. Further, a method for producing the lithium secondary battery of the present invention is not particularly limited if it is a method for allowing the lithium secondary battery to be obtained, and the same method as a method for producing a general lithium secondary battery may be used.

C. Method for Producing Anode Material

Next, a method for producing an anode material of the present invention is described. The method for producing an anode material of the present invention comprises steps of: a preparation step of preparing a reaction liquid containing: a metal oxide represented by a general formula of MₓO_{y} (M is a metal) or a metal represented by a general formula of M, which causes an alloying reaction or a conversion reaction with Li; a polymer compound having an acid group in a side chain; and a polar solvent; and a reaction step of reacting the metal oxide or the metal with the polymer compound by stirring the reaction liquid while heating.

According to the present invention, it is conceived that the metal oxide or the metal are reacted with the polymer compound, so that a metal atom of the metal oxide or the metal bonds to an acid group of the polymer compound by interaction, and the metal atom may be highly dispersed into the anode material by reason of bonding in an atomic level. Thus, even though the shape change of the anode material in accordance with the insertion elimination of lithium is caused, the metal atom previously dispersed into the anode material in an atomic level allows favorable electrical conductivity to be maintained with time, and the anode material capable of improving cycling characteristics of a lithium secondary battery may be obtained.

FIG. 2 is a flow chart showing an example of the method for producing an anode material of the present invention. In FIG. 2, first, bismuth oxide (Bi₂O₃), a polyacrylic acid and water are prepared as a starting material to prepare a reaction liquid by mixing these at a predetermined ratio (preparation step). Next, Bi₂O₃ and a polyacrylic acid are reacted by stirring this reaction liquid while heating (reaction step). Thus, the anode material may be obtained.

The method for producing an anode material of the present invention is hereinafter described in each step.

1. Preparation Step

First, the preparation step in the present invention is described. The preparation step in the present invention is a step of preparing a reaction liquid containing a metal oxide represented by a general formula of MₓO_{y} (M is a metal) or a metal represented by a general formula of M, which cause an alloying reaction or a conversion reaction with Li, a polymer compound having an acid group in a side chain, and a polar solvent.

Incidentally, the metal oxide, the metal and the polymer compound are the same as the contents described in the ‘A. Anode material’; therefore, the description herein is omitted.

The polar solvent used for the present invention is not particularly limited if the polar solvent may react a metal atom of the metal oxide or the metal with an acid group in a side chain of the polymer compound; examples thereof include water, alcohol, ester, amide, nitrile, sulfoxide, sulfone and ether, and water is preferable above all. The reason therefor is that it is inexpensive in cost.

The concentration of the metal oxide or the metal in the reaction liquid prepared by the present step is not particularly limited, but is selected properly in accordance with the composition or the like of an intended anode material. The concentration is, for example, preferably within a range of 0.1% by weight to 70% by weight, and more preferably within a range of 1% by weight to 30% by weight.

Further, the concentration of the polymer compound in the reaction liquid prepared by the present step is not particularly limited but is selected properly in accordance with the composition or the like of an intended anode material. The concentration is, for example, preferably within a range of 0.1% by weight to 70% by weight, and more preferably within a range of 1% by weight to 30% by weight.

2. Reaction Step

Next, the reaction step in the present invention is described. The reaction step in the present invention is a step of reacting the metal oxide or the metal with the polymer compound by stirring the reaction liquid while heating. In the present step, the metal oxide or the metal is reacted with the polymer compound; specifically, a metal atom of the metal oxide or the metal is bonded to an acid group in a side chain of the polymer compound to thereby synthesize an anode material.

The heating temperature in the present step is not particularly limited if the heating temperature may react the metal oxide or the metal with the polymer compound The heating temperature is, for example, preferably within a range of 0° C. to 200° C., and more preferably within a range of 50° C. to 150° C.

Further, the reaction time in the present step is not particularly limited if the reaction time may sufficiently advance a reaction of the metal oxide or the metal with the polymer compound. The heating temperature is, for example, preferably within a range of 1 hour to 500 hours, and more preferably within a range of 3 hours to 200 hours.

A stirring method used for the present step is not particularly limited if the stirring method may uniformly mix the metal oxide or the metal with the polymer compound in the polar solvent; examples thereof include a magnetic stirrer, a mechanical stirrer, vibration stirring and ultrasonic dispersion.

In the present step, a reactant between the metal oxide or the metal, and the polymer compound, that is, the anode material may be ordinarily obtained by condensing the reaction liquid after stirring while heating, and then drying under reduced pressure while heating.

3. Others

The method for producing an anode material of the present invention may properly have optional steps as required except for the preparation step and the reaction step as essential steps. Examples of such steps include a heating step and a drying step.

Incidentally, the present invention is not limited to the embodiments. The embodiments are exemplification, and any is included in the technical scope of the present invention if it has substantially the same constitution as the technical idea described in the claims of the present invention and offers similar operation and effect thereto.

### EXAMPLES

The present invention is described more specifically while showing examples hereinafter.

### Synthesis Example 1

### Synthesis of Reactant

First, bismuth oxide (Bi₂O₃), a polyacrylic acid with a number-average molecular weight of 250000 and water were prepared as a starting material. Dissolved was 28 g of the polyacrylic acid 2800 ml of the water and 31 g of the bismuth oxide was further added thereto to prepare a reaction liquid. Next, this reaction liquid was stirred at a temperature of 80° C. for three days, condensed and thereafter dried under reduced pressure at a temperature of 120° C. to thereby obtain 58 g of a reactant.

### Synthesis Example 2

First, tin oxide (SnO), a polyacrylic acid with a number-average molecular weight of 250000 and water were prepared as a starting material. Dissolved was 28 g of the polyacrylic acid in 2800 ml of the water and 27 g of the tin oxide was further added thereto to prepare a reaction liquid. Next, this reaction liquid was stirred for four days while heated and refluxed under argon gas, condensed and thereafter dried under reduced pressure at a temperature of 120° C. to thereby obtain 54 g of a reactant.

### [Evaluations 1]

(X-Ray Diffraction Measurement)

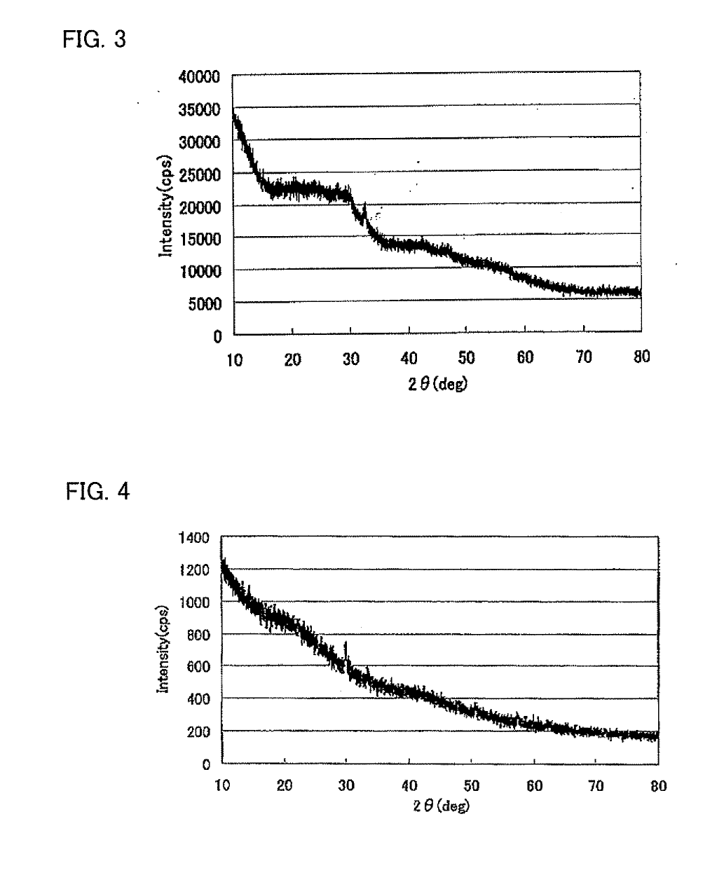

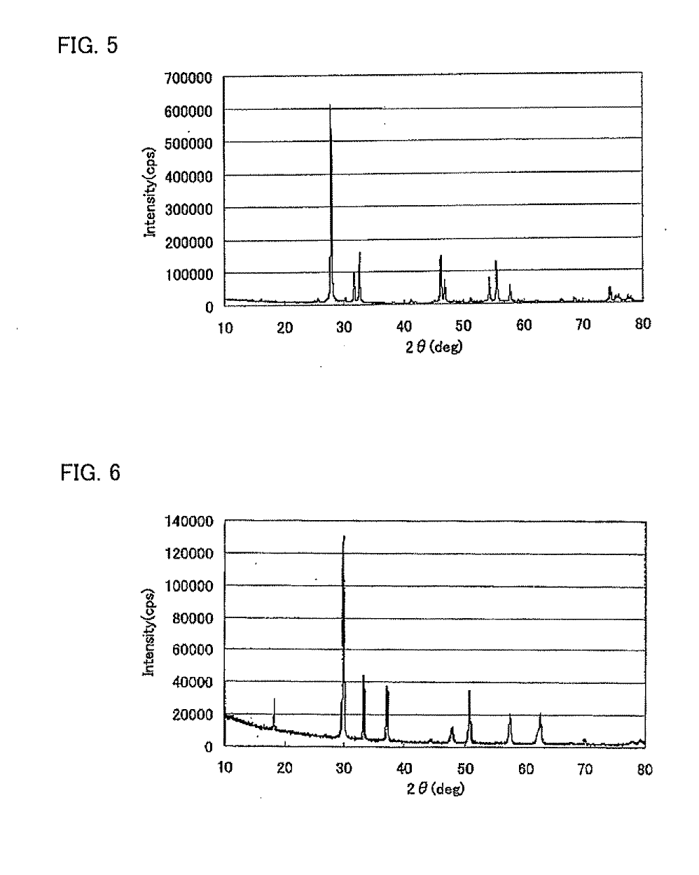

X-ray diffraction (XRD) measurement was performed for the reactants obtained in Synthesis Examples 1 and 2. The results are shown in FIGS. 3 and 4 respectively. Further, XRD measurement was performed for the bismuth oxide (Bi₂O₃) and the tin oxide (SnO). The results are shown in FIGS. 5 and 6 respectively.

As shown in FIG. 5, in XRD measurement result of Bi₂O₃, a plurality of diffraction peaks were detected and it was confirmed that Bi₂O₃ had crystallinity; meanwhile, as shown in FIG. 3, in XRD measurement result of the reactant obtained in Synthesis Example 1, no diffraction peaks were detected and a halo pattern was obtained, so that it was confirmed that the reactant obtained in Synthesis Example 1 was a reactant between Bi₂O₃ and polyacrylic acid.

On the other hand, as shown in FIG. 6, in XRD measurement result of SnO, a plurality of diffraction peaks were detected and it was confirmed that SnO had crystallinity; meanwhile, as shown in FIG. 4, in XRD measurement result of the reactant obtained in Synthesis Example 2, no diffraction peaks were detected and a halo pattern was obtained, so that it was confirmed that the reactant obtained in Synthesis Example 2 was a reactant between SnO and polyacrylic acid.

### Example 1

### Preparation of Anode Material

Milled by ball mill for an hour was 10 g of the reactant obtained in Synthesis Example 1, and thereafter 1 g of acetylene black was added thereto and subject to mechanical milling for three hours to regard the obtained powder as an anode material.

(Production of Evaluation Battery)

First, 10 g of the anode material and 0.6 g of carbon powder as a conductive material were introduced into 7.8 g of a n-methylpyrrolidone solution as a solvent, in which 1.2 g of a polyamic acid as a precursor of a binder was dissolved, and kneaded until uniformly mixed to produce a paste. Subsequently, 2.4 g of n-methylpyrrolidone was added to this paste and kneaded, and thereafter n-methylpyrrolidone was further added thereto to adjust viscosity, and the paste was applied onto one side of a Cu current collector having a thickness of 10 μM with a texture amount of 4.5 mg/cm², and dried. In addition, the obtained member was pressed and burned at a temperature of 350° C. for two hours under a nitrogen atmosphere to thereby form a test electrode having a paste thickness of 32 μm and a density of 1.4 g/cm³.

Next, the test electrode was used for a working electrode and metal Li was used for a counter electrode to produce a CR2032-type coin cell (an evaluation battery). Incidentally, a porous separator made of polyethylene (PE) was used for a separator. Further, a solution, in which lithium hexafluorophosphate (LiPF₆) as a supporting electrolyte was dissolved in a mixed solvent such that ethylene carbonate (EC) and dimethyl carbonate (DMC) were mixed at a volume ratio of 3:7 so as to be a concentration of 1 mol/l, was used for a liquid electrolyte.

### Comparative Example 1

An evaluation battery was obtained in the same manner as Example 1 except for replacing 10 g of the anode material with 10 g of bismuth oxide (Bi₂O₃) in the production of the evaluation battery of Example 1.

### Example 2

### Preparation of Anode Material

Milled by ball mill for an hour was 10 g of the reactant obtained in Synthesis Example 2, and thereafter 1 g of acetylene black was added thereto and subject to mechanical milling for three hours to regard the obtained powder as an anode material.

(Production of Evaluation Battery)

First, 10 g of the anode material and 0.6 g of carbon powder as a conductive material were introduced into 7.8 g of a n-methylpyrrolidone solution as a solvent, in which 1.2 g of a polyamic acid as a precursor of a binder was dissolved, and kneaded until uniformly mixed to produce a paste. Subsequently, 2.4 g of n-methylpyrrolidone was added to this paste and kneaded, and thereafter n-methylpyrrolidone was further added thereto to adjust viscosity, and the paste was applied onto one side of a Cu current collector having a thickness of 10 μm with a texture amount of 5.3 mg/cm², and dried. In addition, the obtained member was pressed and burned at a temperature of 350° C. for two hours under a nitrogen atmosphere to thereby form a test electrode having a paste thickness of 25 μm and a density of 2.1 g/cm³.

Next, the test electrode was used for a working electrode and metal. Li was used for a counter electrode to produce a CR2032-type coin cell (an evaluation battery). Incidentally, a porous separator made of polyethylene (PE) was used for a separator. Further, a solution, in which lithium hexafluorophosphate (LiPF₆) as a supporting electrolyte was dissolved in a mixed solvent such that ethylene carbonate (EC) and dimethyl carbonate (DMC) were mixed at a volume ratio of 3:7 so as to be a concentration of 1 mol/l, was used for a liquid electrolyte.

### Comparative Example 2

An evaluation battery was obtained in the same manner as Example 2 except for replacing 10 g of the anode material with 10 g of tin oxide (SnO) in the production of the evaluation battery of Example 2.

### [Evaluations 2]

(Battery Characteristics Evaluation)

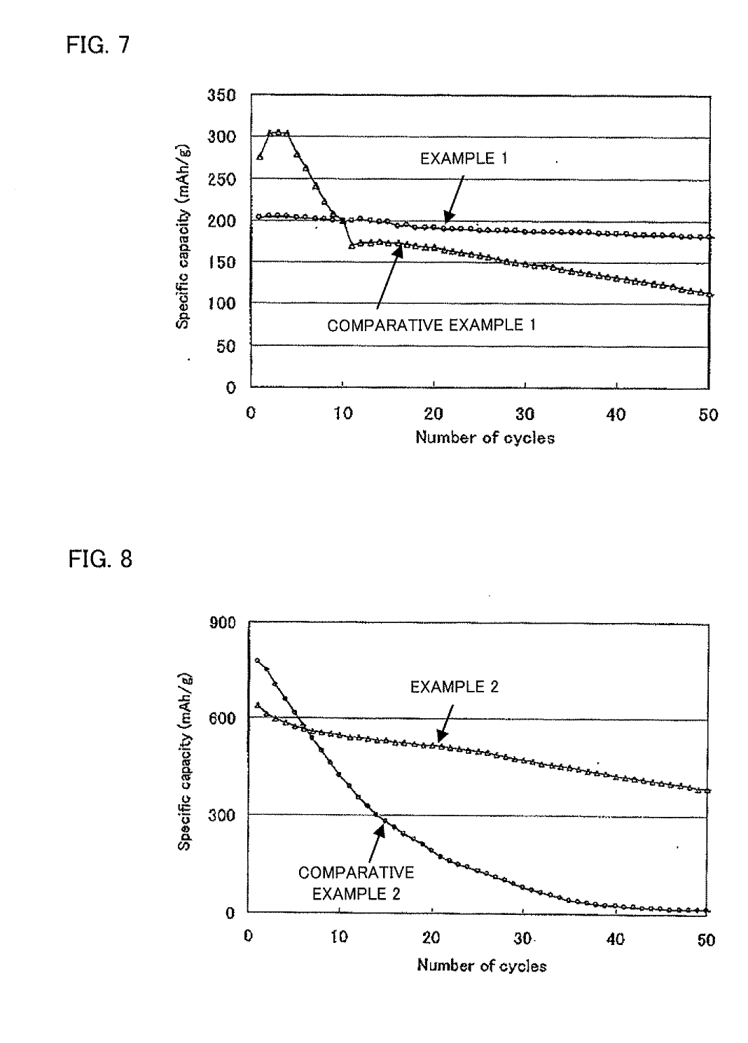

Charge and discharge were repeated by using the evaluation batteries obtained in Example 1 and Comparative Example 1 at a battery evaluation environment temperature of 25° C. and a current rate of 0.1 C. The voltage range was determined at 0.2 V to 1.5 V. FIG. 7 shows a result of evaluating cycling characteristics.

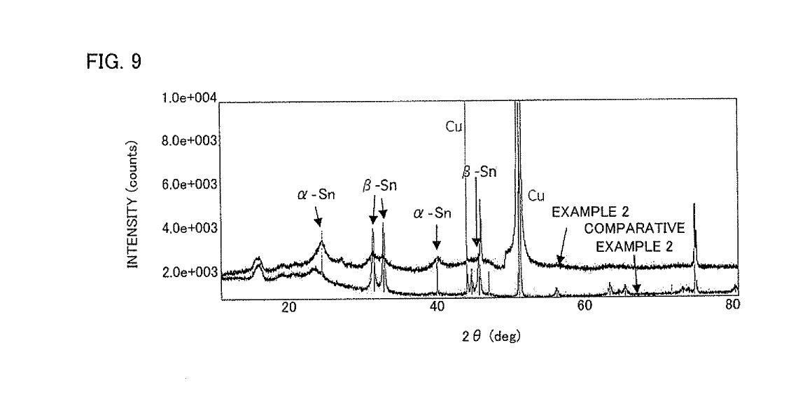

Further, charge and discharge were repeated by using the evaluation batteries obtained in Example 2 and Comparative Example 2 at a battery evaluation environment temperature of 25° C. and a current rate of 0.1 C. The voltage range was determined at 0.01 V to 1.5 V. FIG. 8 shows a result of evaluating cycling characteristics. In addition, X-ray diffraction (XRD) measurement was performed for the working electrode (the test electrode) after 60-cycle charge and discharge of the evaluation batteries obtained in Example 2 and Comparative Example 2. The result was shown in FIG. 9.

As shown in FIG. 7, it was confirmed that the use of the reactant between Bi₂O₃ and polyacrylic acid as the anode material allowed cycling characteristics to be improved as compared with the case of using Bi₂O₃ as the anode material. It is conceived that the reason therefor is that Bi is highly dispersed in a level of molecular structure.

Further, as shown in FIG. 8, it was confirmed that the use of the reactant between SnO and polyacrylic acid as the anode material allowed cycling characteristics to be improved as compared with the case of using SnO as the anode material. It is conceived that the reason therefor is that Sn is highly dispersed in a level of molecular structure.

On the other hand, as shown in FIG. 9, α-Sn and β-Sn were included in Example 2 using the reactant between SnO and polyacrylic acid as the anode material; meanwhile, in Comparative Example 2 using SnO as the anode material, α-Sn was not included and only β-Sn was included, so that it was confirmed that metallic phases of the two were different. Thus, in Example 2, it is conceived that the two metallic phases mutually relieve volume change during the insertion elimination of Li to improve discharge capacity maintenance factor.

### REFERENCE SIGNS LIST

1 . . . Cathode active material layer
2 . . . Anode active material layer
3 . . . Electrolyte layer
4 . . . Cathode current collector
5 . . . Anode current collector
6 . . . Battery case
10 . . . Lithium secondary battery

1. An anode material, comprising a reactant between: a metal oxide represented by a general formula of MₓO_{y} (M is a metal) or a metal represented by a general formula of M, causing an alloying reaction or a conversion reaction with Li; and a polymer compound having an acid group in a side chain.

2. The anode material according to claim 1, wherein the M is Bi, Sb, Sn, Si, Al, Pb, In, Mg, Ti, Zr, V, Fe, Cr, Cu, Co, Mn, Ni, Zn, Nb, Ru, Mo, Sr, Y, Ta, W, or Ag in the general formula.

3. The anode material according to claim 1, wherein the metal oxide or the metal is bismuth oxide (Bi₂O₃), tin oxide (SnO), or tin (Sn).

4. The anode material according to claim 1, wherein the acid group is a carboxylic acid group or a sulfonic acid group.

5. A lithium secondary battery comprising a cathode active material layer, an anode active material layer, and an electrolyte layer formed between the cathode active material layer and the anode active material layer,
wherein the anode active material layer is formed by using the anode material according to claim 1.

6. A method for producing an anode material, comprising steps of:
a preparation step of preparing a reaction liquid containing: a metal oxide represented by a general formula of MₓO_{y} (M is a metal) or a metal represented by a general formula of M, causing an alloying reaction or a conversion reaction with Li; a polymer compound having an acid group in a side chain; and a polar solvent; and
a reaction step of reacting the metal oxide or the metal with the polymer compound by stirring the reaction liquid while heating.
